(19) United States
(12) Patent Application Publication
(10) Pub. No.: US 2009/0110044 A1
(43) Pub. Date: Apr. 30, 2009

(54) Method and Apparatus for Deciding a Channel Impulse Response

(75) Inventors: Wen-Rong Wu, Hsinchu City (TW); Shiang-Lun Kao, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: NATIONAL CHIAO TUNG UNIVERSITY, Hsinchu City (TW)

(21) Appl. No.: 12/107,126

(22) Filed: Apr. 22, 2008

(30) Foreign Application Priority Data
Oct. 26, 2007 (TW) 96140221

(51) Int. Cl. H04L 27/01

(52) U.S. Cl. 375/231

(57) ABSTRACT

Method and apparatus for deciding a channel impulse response for an OFDM system are provided. First, a channel frequency response is generated by using a plurality of pilot tones of a signal. A channel impulse response is generated by applying the IFFT to the channel frequency response. A plurality of selected channel taps are derived by comparing a plurality of channel taps related to the channel impulse response with a reference threshold. Finally, the channel impulse response is generated by calculating channel impulse respose according to the selected channel taps. This method calculates the channel impulse response in time domain and frequency domain so that the calculation complexity can be reduced, and the system efficiency can be enhanced.

This application claims the benefit of priority based on Taiwan Patent Application No. 096140221 filed on Oct. 26, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a method and an apparatus for deciding a channel impulse response; more particularly, relates to a method and an apparatus for deciding a channel impulse response that are adapted to an Orthogonal Frequency Division Multiplexing (OFDM) system.

2. Descriptions of the Related Art

As more and more websites are providing high-quality audio/video services in recent years, demand for high-speed data transmission is rapidly increased accordingly. An Orthogonal Frequency Division Multiplexing (OFDM) system, which is a new technology capable of utilizing the frequency spectrum efficiently, just caters for this demand. In addition to increasing the efficiency of the frequency spectrum usage, the OFDM technology is also able to eliminate multipath fading effect. As a result, it has found application in a variety of wireless communication systems. Owing to these advantages, OFDM has been adopted in various commercial communication systems, such as Digital Audio Broadcasting (DAB) systems, Digital Video Broadcasting-Terrestrial (DVB-T) systems, and wireless local area network systems. OFDM has also been proposed to act as a wireless broadband accessing standard (e.g., IEEE 802.16 (WiMax)) and a core technology for the 4G (4^{th} generation) wireless mobile communication.

For high-speed data transmission, a wireless communication channel may experience a channel fading in both the time domain and the frequency domain. Due to the time-varying nature of a wireless communication channel, pilot tones are usually packed into a transmitted signal to facilitate channel estimation. Such additional pilot tones slow down the overall data transmission speed, and degrade the spectrum efficiency. In order to mitigate such an adverse effect, a limitation is generally made on the number of the pilot tones. Accordingly, how to use a limited number of pilot tones to estimate a channel has been a major concern in design of a wireless receiving system.

In an OFDM system, a received signal is considered to be equivalent to a channel response multiplied with a transmitted data symbol. Since a simple way is to equalize a received signal by a frequency-domain equalizer (FEQ), so channel estimation is generally made in the frequency domain in an OFDM system.

As described above, due to limitation on the number of pilot tones, channel responses corresponding non-pilot tones are usually derived by an interpolation algorithm in the channel estimation. However, a major problem arises when using an interpolation algorithm in the frequency domain; that is, in case of a large channel delay spread, the bandwidth will be narrowed and it is less likely to obtain a correct interpolated result.

Another way is to estimate a channel in the time domain. Conventional methods for channel estimation include the least-square (LS) method and the minimum-mean-square-error (MMSE) method. Although these methods may obtain better results, the associated computational complexity is usually relatively high. Moreover, in the LS method, statistical characteristics of a channel have to be known in advance, which is impractical in practice.

Accordingly, it is highly desirable in the art to decrease the computational complexity involved in deciding a channel response in a wireless communication receiving system.

### SUMMARY OF THE INVENTION

One objective of this invention is to provide a method for deciding a channel impulse response that is adapted to an OFDM system. With this method, the channel frequency response is roughly estimated by use of pilot tones in the frequency domain on one hand, and on the other hand, the channel impulse response is calculated by using selected channel taps, wherein the selected channel taps is selected in the time domain by comparison. In this way, the computational complexity is decreased, while the performance of the OFDM system is improved.

To this end, the method comprises the steps of: generating a channel frequency response of a signal by using a plurality of pilot tones of the signal; generating a channel impulse response by applying the Inverse Fast Fourier Transform (IFFT) to the channel frequency response; deriving a plurality of selected channel taps by comparing a plurality of channel taps related to the channel impulse response with a reference threshold; and generating the channel impulse response by using the selected channel taps to calculate channel impulse.

Another objective of this invention is to provide an apparatus for deciding a channel impulse response that is adapted to an OFDM system. This apparatus is capable of deciding the channel impulse response by combining operations in both the time domain and the frequency domain together, thus decreasing the computational complexity and increasing performance of the OFDM system.

To this end, the apparatus comprises a channel frequency response generator, an inverse fast Fourier transformer, a comparator, and a channel impulse response calculator. The channel frequency response generator is configured to generate a channel frequency response of a signal by using a plurality of pilot tones of the signal. The inverse fast Fourier transformer is configured to generate a channel impulse response by applying the IFFT to the channel frequency response. The comparator is configured to derive a plurality of selected channel taps by comparing a plurality of channel taps related to the channel impulse response with a reference threshold. The channel impulse response calculator is configured to generate the channel impulse response by using the selected channel taps to calculate channel impulse.

In summary, this invention provides a method and an apparatus for deciding a channel impulse response. With this invention, the channel frequency response is roughly estimated in the frequency domain on one hand, and some channel taps are selected in the time domain to calculate the channel impulse response on the other hand. As a result, the excessively high computational complexities present in conventional methods, such as the least-square (LS) method and the minimum-mean-square-error (MMSE) method, are decreased and performance of the system is increased.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic block diagram of a first embodiment of this invention;

FIG. 2 is a flow diagram of a second embodiment of this invention;

FIG. 3 is a flow diagram of generating a first channel frequency response of the second embodiment;

FIG. 4a is a partial flow diagram of the second embodiment of this invention;

FIG. 4b is a partial flow diagram of the second embodiment of this invention;

FIG. 4c is a partial flow diagram of the second embodiment of this invention; and

FIG. 5 is a flow diagram of generating a second channel frequency response of the second embodiment.

### DESCRIPTION OF THE PREFERRED EMBODIMENT

The present invention will now be described with reference to embodiments, which are a method and an apparatus for deciding a channel impulse response. However, these embodiments are not intended to limit that this invention can only be embodied in any specific context, applications, or with particular implementations described in these embodiments. Therefore, description of these embodiments is only intended to illustrate rather than to limit this invention. It should be noted that, in the following embodiments and attached drawings, elements not directly related to this invention are omitted from depiction.

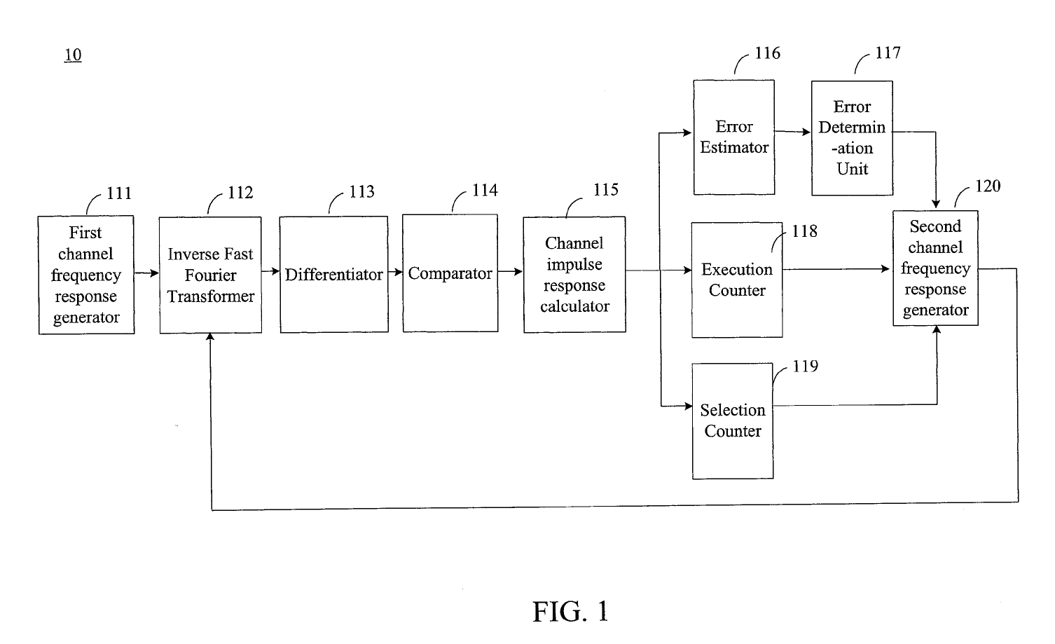

FIG. 1 depicts an apparatus 10 for deciding a channel impulse response in accordance with a first embodiment of this invention, which is adapted to a receiving end of an OFDM system. The apparatus 10 comprises a first channel frequency response generator 111, an inverse fast Fourier transformer 112, a differentiator 113, a comparator 114, and a channel impulse response calculator 115. These modules will now be described in detail with reference to operation of the apparatus 10.

Upon the receiving end of the OFDM system receiving a signal, the first channel frequency response generator 111 uses a plurality of pilot tones of the signal to generate a first channel frequency response of the signal for subsequent processing. In particular, since in the OFDM system, some pilot tones are typically packed into a transmitted signal by a transmitting end to aid the receiving end proceeding channel estimation. Therefore, the receiving end can use these pilot tones of the received signal to calculate the channel frequency response.

The first channel frequency response generator 111 comprises a fast Fourier transformer (not shown), a channel frequency response calculator (not shown), and an interpolation operator (not shown) to generate the first channel frequency response. Initially, the fast Fourier transformer applies the fast Fourier transform (FFT) to the signal. Then, the channel frequency response calculator calculates an initial channel frequency response by use of the pilot tones, wherein the initial channel frequency response comprises a plurality of initial sub-channel responses. Finally, the interpolation operator perform interpolation by using the initial sub-channel responses to derive a plurality of interpolated sub-channel responses. The first channel frequency response comprises the initial sub-channel responses and the interpolated sub-channel responses.

Subsequent to the generation of the first channel frequency response, the inverse fast Fourier transformer 112 generates a first channel impulse response by applying the IFFT to the first channel frequency response, wherein the first channel impulse response comprises a plurality of initial channel taps. Specifically, the inverse fast Fourier transformer 112 transforms the first channel frequency response in the frequency domain into the first channel impulse response in the time domain, so as to subsequently estimate the channel impulse response in the time domain.

After the generation of the first channel impulse response, the differentiator 113 differentiates the initial channel taps to derive a plurality of first channel taps. Then, the comparator 114 compares the first channel taps, which are related to the first channel impulse response, with a first reference threshold to derive a plurality of first selected channel taps.

The requirement of the differentiator 113 is now described. As mentioned, the first channel impulse response comprises the initial channel taps. If the comparator 114 directly compare the initial channel taps with the first reference threshold to derive the first selected channel taps, the resultant first selected channel taps would have larger errors. This is because the first channel frequency response comprises low-passed signals, the first selected channel taps obtained by directly comparing the initial channel taps with the first reference threshold would comprises fake taps, i.e. some taps which are not really the first selected channel taps. Therefore, by using the differentiator 113 to differentiate the initial channel taps to derive the first channel taps, the low-passed signals in the channel response can be removed. As a result, the first selected channel taps generated from the comparator 114 will be rendered more accurate.

In other embodiments, other modules that are able to filter low-passed signals and/or noises may be substituted for the differentiator 113. Alternatively, in some other embodiments, the differentiator 113 may be omitted without adding other substitute modules, in which case the comparator 114 processes the first channel impulse response at first and then compare a plurality of first channel taps related to the processed first channel impulse response with the first reference threshold.

Additionally, the comparator 114 may adopt several methods to derive the first selected channel taps. The first exemplary method is to utilize a strength value of each of the first channel taps, the first channel taps with the strength value greater than the first reference threshold are selected to be the first selected channel taps. The second exemplary method selects the first channel taps with the strength values greater than the first reference threshold and also with the greatest N strength values, i.e., N greatest first channel taps are selected to be the first selected channel taps, wherein N is a default selection number. These methods are provided for purpose of illustration rather than to limit scope of this invention.

Finally, the channel impulse response calculator 115 generates the channel impulse response by using the first selected channel taps to calculate channel impulse. Specifically, once the first selected channel taps are derived, the channel impulse response calculator 115 calculates the channel impulse response of the first selected channel taps by the least-square (LS) method. As the LS method is well-known to those of ordinary skill in the OFDM art, a further description thereof will be omitted herein.

By the aforementioned configurations, appropriate channel taps can be selected to calculate the channel impulse response. However, in case of a poor channel quality, some consecutive channel taps may fail to be selected, imposing an adverse effect on the accuracy of the calculated channel impulse response. In order to improve the accuracy of the resultant channel impulse response, additional modules/devices may be added in the apparatus 10 to determine if the selection by the aforesaid modules/devices has to be repeated. In the following, three approaches (three sets of modules/devices) for determining whether to use the aforesaid modules/devices repeatedly will be described.

In a first approach, an error estimator 116 and an error determination unit 117 are further provided in the apparatus 10 to make further determination. Firstly, the error estimator 116 calculates an estimated error of the channel impulse response. More specifically, the error estimator 116 may generate the estimated error by a least-square-error (LSE) method. However, other methods may also be used to generate the estimated error in other embodiments. Subsequently, the error determination unit 117 determines whether the estimated error exceeds a default threshold of error. If the answer is yes, the aforesaid modules/devices will be used again.

In a second approach, an execution counter 118 is further provided in the apparatus 10 to determine whether a present execution times is fewer than a default execution times. If the answer is yes (i.e., the default execution times has not been reached yet), the aforesaid modules/devices will be used again.

In a third approach, a selection counter 119 is further provided in the apparatus 10 to determine whether a number of the first channel taps that is greater than the first reference threshold is smaller than a default total selection number. If the answer is yes, which means that the total number of the first channel taps has not reached the default total selection number yet, the aforesaid modules/devices will be used again.

It should be noted that the three sets of modules/devices (i.e. the error estimator 116 and the error determination unit 117, execution counter 118, and the selection counter 119) described above may also be used in combination. For example, the selection counter 119 and the execution counter 118 may be used together to set the total selection number and the execution times respectively, and finally the error estimator 116 and the error determination unit 117 are further used to determine whether to proceed the execution. In this way, the system will be rendered more flexible. Additionally, although the apparatus 10 in this embodiment is further provided with the aforementioned three sets of modules/devices, the apparatus 10 in other embodiments may be further provided with only the error estimator 116 and the error determination unit 117, with only the execution counter 118, or with only the selection counter 119.

A second channel frequency response generator 120 has to be further provided in all the three approaches. If it is determined that the aforesaid modules/devices have to be used again for selection, the second channel frequency response generator 120 will generate a second channel frequency response by using the first selected channel taps and the first channel frequency response prior to the repeated execution. The object is to deduct the channel impulse response generated by the first selected channel taps so that the second execution will give a correct result. Two approaches used by the second channel frequency response generator 120 to generate a second channel frequency response are described in the following paragraphs.

In a first approach, the second channel frequency response generator 120 comprises a temporary signal transformer (not shown), a guard-band filter (not shown) and a signal deduction unit (not shown). The temporary signal transformer applies the FFT to the first selected channel taps to derive a temporary signal. Then, to the guard-band filter applies the guard-band filtering to the temporary signal to derive a filtered signal so as to remove effect of the guard-band. Finally, the signal deduction unit generates the second channel frequency response by deducting the filtered signal from the first channel frequency response.

In another approach, the second channel frequency response generator 120 is designed as a low-pass filter (not shown). Compared to the first approach, this approach does not perform the FFT and IFFT operations, thus computational complexity is decreased.

After generating the second channel frequency response, the second channel frequency response generator 120 transmits it to the inverse fast Fourier transformer 112, which applies the IFFT to the second channel frequency response to generate a second channel impulse response. Then, the comparator 114 compares a plurality of second channel taps related to the second channel impulse response with a second reference threshold value to derive second selected channel taps. The channel impulse response calculator 115 then calculates channel impulse response by using the first selected channel taps and the second selected channel taps to generate the channel impulse response. In other words, as a final result, the first selected channel taps and the second selected channel taps are combined to generate the channel response. A detailed description of the above operations is just the same as previously described, and thus will be omitted herein.

It should be noted that, this invention is not limited to using only the first selected channel taps and the second selected channel taps to generate the channel impulse response, but may also be executed a number of times to generate more selected channel taps. More selected channel taps generate more accurate channel impulse response.

The apparatus 10 for deciding a channel impulse response in this embodiment roughly estimates a channel frequency response in the frequency domain on one hand and calculates channel impulse response by selecting channel taps in the time domain. As a result, the computational complexity is decreased. Furthermore, the repeated execution may further increase accuracy of the channel impulse response, thus effectively increasing performance of the system.

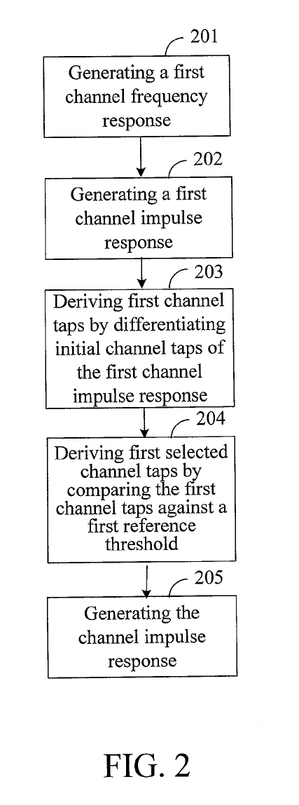

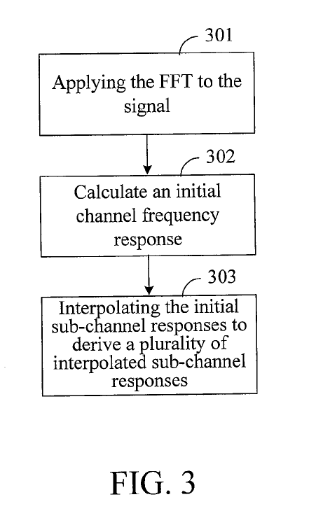

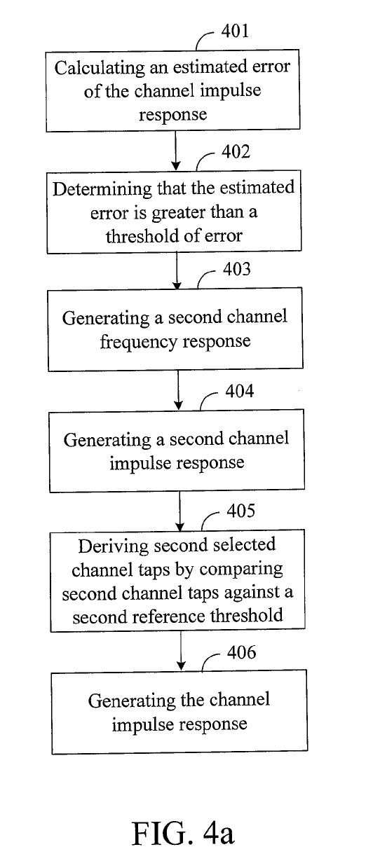

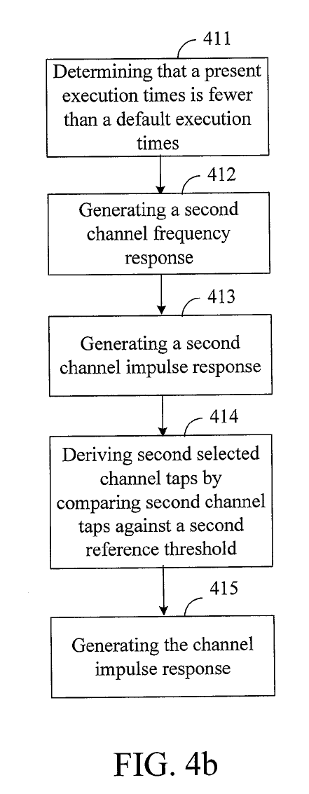

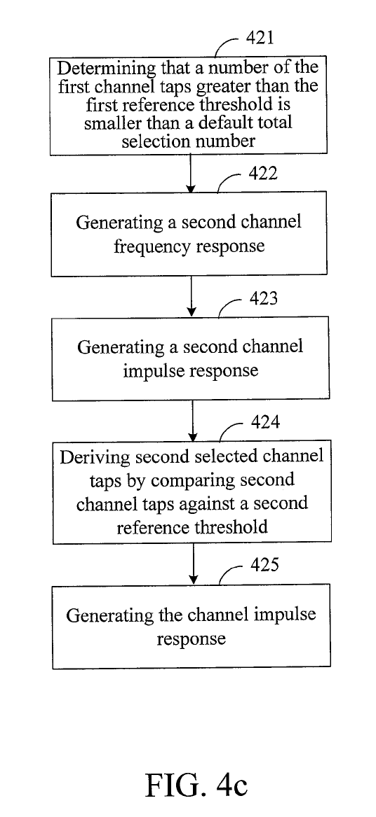

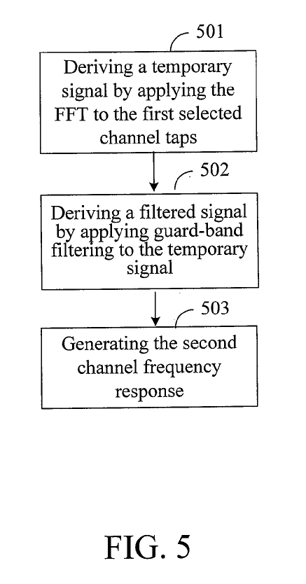

A second embodiment of this invention is a method for deciding a channel impulse response that is adapted to an OFDM system, a flow diagram of which is depicted in FIG. 2, FIG. 3, FIGS. 4a-4c, and FIG. 5. This method of the second embodiment is adapted to an OFDM system as well as the apparatus 10 depicted in FIG. 1. Upon a receiving end of the OFDM system receiving a signal, steps of this method can be executed to decide a channel impulse response.

Initially in step 201, a first channel frequency response of the signal is generated by using a plurality of pilot tones of the signal. Step 201 may be accomplished by the steps shown in FIG. 3. Initially in step 301, the FFT is applied to the signal. In step 302, these pilot tones are used to calculate an initial channel frequency response having a plurality of initial sub-channel responses. In step 303, the initial sub-channel responses are interpolated to derive a plurality of interpolated sub-channel responses, wherein the first channel frequency response comprises the initial sub-channel responses and the interpolated sub-channel responses. Details of these steps are just as described in the first embodiment and therefore are omitted herein. Thus, step 201 is completed.

Then in step 202, a first channel impulse response is generated by applying the IFFT to the first channel frequency response. Then step 203 is executed, a plurality of first channel taps are derived by differentiating a plurality of initial channel taps of the first channel impulse response. Next, in step 204, a plurality of first selected channel taps are derived by comparing the first channel taps (being related to the first channel impulse response) with a first reference threshold. Since each of the first channel taps has a strength value, step 204 may select the first channel taps with the strength value greater than a first reference threshold to be the first selected channel taps. Alternatively, step 204 may select the first channel tap with the strength values greater than the first reference threshold and also with the greatest N strength values to be the first selected channel taps, where N is a default selection number. Details of these steps are just as described in the first embodiment and therefore are omitted herein.

Finally in step 205, the channel impulse response is generated by using the first selected channel taps to calculate channel impulse. Details of these steps are just as described in the first embodiment and therefore are omitted herein.

Additionally, just as in the first embodiment, subsequent to step 205 in the method of the second embodiment, three different approaches may be used to repeat the operations to generate the channel impulse response, in order to render the resultant channel impulse response more accurate. Steps of the three approaches will be described as follows.

A flow diagram of the first approach is depicted in FIG. 4a. Initially, in step 401, an estimated error of the channel impulse response is calculated. In step 402, it is determined that the estimated error is greater than a threshold of error. In step 403, a second channel frequency response is generated by using the first selected channel taps and the first channel frequency response. Then in step 404, a second channel impulse response is generated by applying the IFFT to the second channel frequency response. In step 405, a plurality of second selected channel taps are derived by comparing a plurality of second channel taps related to the second channel impulse response against a second reference threshold. Finally, in step 406, the channel impulse response is generated by using the first selected channel taps and the second selected channel taps to calculate channel impulses. Details of these steps are just as described in the first embodiment and therefore are omitted herein.

A flow diagram of the second approach is depicted in FIG. 4b. Initially, in step 411, it is determined that a present execution times is fewer than a default execution times. In step 412, a second channel frequency response is generated by using the first selected channel taps and the first channel frequency response. In step 413, a second channel impulse response is generated by applying the IFFT to the second channel frequency response. In step 414, a plurality of second selected channel taps are derived by comparing a plurality of second channel taps related to the second channel impulse response with a second reference threshold. Finally, in step 415, the channel impulse response is generated by using the first selected channel taps and the second selected channel taps to calculate channel impulse. Details of these steps are just as described in the first embodiment and therefore are omitted herein.

A flow diagram of the third approach is depicted in FIG. 4c. Initially, in step 421, it is determined that a number of the first channel taps that is greater than the first reference threshold is smaller than a default total selection number. In step 422, a second channel frequency response is generated by using the first selected channel taps and the first channel frequency response. In step 423, a second channel impulse response is generated by applying the IFFT to the second channel frequency response. In step 424, a plurality of second selected channel taps are derived by comparing a plurality of second channel taps related to the second channel impulse response with a second reference threshold. Finally, in step 425, the channel impulse response is generated by using the first selected channel taps and the second selected channel taps to calculate channel impulse. Details of these steps are just as described in the first embodiment and therefore are omitted herein.

Additionally, in the three approaches of repeating the operations to generate the channel impulse response, the step of generating the second channel frequency response (i.e., step 403 of the first approach, step 412 of the second approach, and step 422 of the third approach) can be executed by the following two approaches.

A flow diagram of a first approach is depicted in FIG. 5. Initially in step 501, a temporary signal is derived by applying the FFT to the first selected channel taps. Next in step 502, a filtered signal is derived by applying guard-band filtering to the temporary signal. Finally in step 503, the second channel frequency response is generated by deducting the filtered signal from the first channel frequency response.

In a second approach, the channel impulse response in time domain is regenerated by using a low-pass filter. Details of these two approaches are just as described in the first embodiment and therefore are omitted herein.

In addition to the steps described above, the second embodiment may also execute all the operations and functions described in the first embodiment. Corresponding operations and functions in the second embodiment will readily occur to those of ordinary skill in the art upon reviewing description of the first embodiment, and therefore will not be further described herein.

As described above, in a method for deciding a channel impulse response in accordance with this embodiment, the channel frequency response in the frequency domain is calculated at first, and the channel impulse response is calculated by selecting channel taps in the time domain. This will not only decrease computational complexity, but also render the final result more accurate by executing repeated operations.

In summary, this invention provides a method and an apparatus for deciding a channel impulse response. With this invention, computational complexity is decreased by combining operations in both the frequency domain and the time domain together in an OFDM system. As a result, the excessively high computational complexity present in conventional methods such as the least-square (LS) method and the minimum-mean-square-error (MMSE) method is avoided. Furthermore, accuracy is obtained over the conventional methods by executing repeated operations.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for deciding a channel impulse response, being adapted to an orthogonal frequency division multiplexing (OFDM) system, the method comprising the steps of:
(a) generating a first channel frequency response of a signal by using a plurality of pilot tones of the signal;
(b) generating a first channel impulse response by applying the inverse fast Fourier transform (IFFT) to the first channel frequency response;
(c) deriving a plurality of first selected channel taps by comparing a plurality of first channel taps related to the first channel impulse response with a first reference threshold; and
(d) generating the channel impulse response by using the first selected channel taps to calculate channel impulse.

2. The method of claim 1, further comprising the steps of:
(e) calculating an estimated error of the channel impulse response;
(f) determining the estimated error being greater than a threshold of error;
(g) generating a second channel frequency response by using the first selected channel taps and the first channel frequency response;
(h) generating a second channel impulse response by applying the IFFT to the second channel frequency response;
(i) deriving a plurality of second selected channel taps by comparing a plurality of second channel taps related to the second channel impulse response with a second reference threshold; and
(j) generating the channel impulse response by using the first selected channel taps and the second selected channel taps to calculate channel impulse.

3. The method of claim 1, further comprising the steps of:
(e) determining a present execution times being fewer than a default execution times;
(f) generating a second channel frequency response by using the first selected channel taps and the first channel frequency response;
(g) generating a second channel impulse response by applying the IFFT to the second channel frequency response;
(h) deriving a plurality of second selected channel taps by comparing a plurality of second channel taps related to the second channel impulse response with a second reference threshold; and
(i) generating the channel impulse response by using the first selected channel taps and the second selected channel taps to calculate channel impulse.

4. The method of claim 1, further comprising the steps of:
(e) determining a number of the first channel taps that is greater than the first reference threshold being smaller than a default total selection number;
(f) generating a second channel frequency response by using the first selected channel taps and the first channel frequency response;
(g) generating a second channel impulse response by applying the IFFT to the second channel frequency response;
(h) deriving a plurality of second selected channel taps by comparing a plurality of second channel taps related to the second channel impulse response with a second reference threshold; and
(i) generating the channel impulse response by using the first selected channel taps and the second selected channel taps to calculate channel impulse.

5. The method of claim 2, wherein the step of generating the second channel frequency response comprises the steps of:
applying the fast Fourier transform (FFT) to the first selected channel taps to derive a temporary signal;
applying guard-band filtering to the temporary signal to derive a filtered signal; and
generating the second channel frequency response by deducting the filtered signal from the first channel frequency response.

6. The method of claim 3, wherein the step of generating the second channel frequency response comprises the steps of:
applying the fast Fourier transform (FFT) to the first selected channel taps to derive a temporary signal;
applying guard-band filtering to the temporary signal to derive a filtered signal; and
generating the second channel frequency response by deducting the filtered signal from the first channel frequency response.

7. The method of claim 4, wherein the step of generating the second channel frequency response comprises the steps of:
applying the fast Fourier transform (FFT) to the first selected channel taps to derive a temporary signal;
applying guard-band filtering to the temporary signal to derive a filtered signal; and
generating the second channel frequency response by deducting the filtered signal from the first channel frequency response.

8. The method of claim 2, wherein the channel impulse response is re-generated by using a low-pass filter.

9. The method of claim 3, wherein the channel impulse response is re-generated by using a low-pass filter.

10. The method of claim 4, wherein the channel impuse response is re-generated by using a low-pass filter.

11. The method of claim 1, wherein each of the first channel taps has a strength value, and the step (c) selects the first channel taps with the strength values greater than the first reference threshold to be the first selected channel taps.

12. The method of claim 1, wherein each of the first channel taps has a strength value, and the step (c) selects the first channel tap with the strength values greater than the first reference threshold and also with the greatest N strength values to be the first selected channel taps, wherein N is a default selection number.

13. The method of claim 1, wherein the step (a) comprises the steps of:
(a1) apply the FFT to the signal;
(a2) calculating an initial channel frequency response by the pilot tones, and the initial channel frequency response comprising a plurality of initial sub-channel responses; and
(a3) generating a plurality of interpolated sub-channel responses by interpolating the initial sub-channel responses;
wherein the first channel frequency response comprises the initial sub-channel responses and the interpolated sub-channel responses.

14. The method of claim 1, further comprising the step of:
deriving the first channel taps by differentiating the initial channel taps of the first channel impulse response.

15. An apparatus for deciding a channel impulse response, being adapted to an OFDM system, the apparatus comprising:
a first channel frequency response generator, configured for generating a first channel frequency response of a signal by using a plurality of pilot tones of the signal;
an inverse fast Fourier transformer, configured for generating a first channel impulse response by applying the IFFT to the first channel frequency response;
a comparator, configured for deriving a plurality of first selected channel taps by comparing a plurality of first channel taps related to the first channel impulse response with a first reference threshold; and
a channel impulse response calculator, configured for generating the channel impulse response by using the first selected channel taps to calculate channel impulse.

16. The apparatus of claim 15, further comprising:
an error estimator, configured for calculating an estimated error of the channel impulse response;
an error determination unit, configured for determining the estimated error being greater than a threshold of error; and
a second channel frequency response generator, configured for generating a second channel frequency response by using the first selected channel taps and the first channel frequency response;
wherein the inverse fast Fourier transformer is further configured for generating a second channel impulse response by applying the IFFT to the second channel frequency response, and the comparator is further configured for deriving a plurality of second selected channel taps by comparing a plurality of second channel taps related to the second channel impulse response with a second reference threshold, and the channel impulse response calculator is further configured for generating the channel impulse response by using the first selected channel taps and the second selected channel taps to calculate channel impulse.

17. The apparatus of claim 15, further comprising:
an execution counter, configured for determining a present execution times being fewer than a default execution times; and
a second channel frequency response generator, configured for generating a second channel frequency response by using the first selected channel taps and the first channel frequency response;
wherein the inverse fast Fourier transformer is further configured for generating a second channel impulse response by applying the IFFT to the second channel frequency response, the comparator is further configured for deriving a plurality of second selected channel taps by comparing a plurality of second channel taps related to the second channel impulse response with a second reference threshold, and the channel impulse response calculator is further configured for generating the channel impulse response by using the first selected channel taps and the second selected channel taps to calculate channel impulse.

18. The apparatus of claim 15, further comprising:
a selection counter, configured for determining a number of the first channel taps that is greater than the first reference threshold being smaller than a default total selection number; and
a second channel frequency response generator, configured for generating a second channel frequency response by using the first selected channel taps and the first channel frequency response;
wherein the inverse fast Fourier transformer is further configured for generating a second channel impulse response by applying the IFFT to the second channel frequency response, the comparator is further configured for deriving a plurality of second selected channel taps by comparing a plurality of second channel taps related to the second channel impulse response with a second reference threshold, and the channel impulse response calculator is further configured for generating the channel impulse response by using the first selected channel taps and the second selected channel taps to calculate channel impulse.

19. The apparatus of claim 16, wherein the second channel impulse response generator comprises:
a temporary signal transformer, configured for applying the FFT to the first selected channel taps to derive a temporary signal;
a guard-band filter, configured for applying the guard-band filtering to the temporary signal to derive a filtered signal; and
a signal deduction unit, configured for generating the second channel frequency response by deducting the filtered signal from the first channel frequency response.

20. The apparatus of claim 17, wherein the second channel impulse response generator comprises:
a temporary signal transformer, configured for applying the FFT to the first selected channel taps to derive a temporary signal;
a guard-band filter, configured for applying the guard-band filtering to the temporary signal to derive a filtered signal; and
a signal deduction unit, configured for generating the second channel frequency response by deducting the filtered signal from the first channel frequency response.

21. The apparatus of claim 18, wherein the second channel impulse response generator comprises:
a temporary signal transformer, configured for applying the FFT to the first selected channel taps to derive a temporary signal;
a guard-band filter, configured for applying the guard-band filtering to the temporary signal to derive a filtered signal; and
a signal deduction unit, configured for generating the second channel frequency response by deducting the filtered signal from the first channel frequency response.

22. The apparatus of claim 16, wherein the second channel frequency response generator is a low-pass filter.

23. The apparatus of claim 17, wherein the second channel frequency response generator is a low-pass filter.

24. The apparatus of claim 18, wherein the second channel frequency response generator is a low-pass filter.

25. The apparatus of claim 15, wherein each of the first channel taps has a strength value, and the comparator selects the first channel taps with the strength values greater than the first reference threshold to be the first selected channel taps.

26. The apparatus of claim 15, wherein each of the first channel taps has a strength value, and the comparator selects the first channel taps with the strength values greater than the first reference threshold also with the greatest N strength values to be the first selected channel taps, wherein N is a default selection number.

27. The apparatus of claim 15, wherein the first channel frequency response generator comprises:
a fast Fourier transformer, configured for applying the FFT to the signal;
a channel frequency response calculator, configured for calculating an initial channel frequency response by the pilot tones, and the initial channel frequency response comprises a plurality of initial sub-channel responses; and
an interpolation operator, configured for generating a plurality of interpolated sub-channel responses by interpolating the initial sub-channel responses;
wherein the first channel frequency response comprises the initial sub-channel responses and the interpolated sub-channel responses.

28. The apparatus of claim 15, further comprising:
a differentiator, configured for deriving the first channel taps by differentiating the initial channel taps of the first channel impulse response.
